(19) United States
(12) Patent Application Publication
(10) Pub. No.: US 2012/0134828 A1
(43) Pub. Date: May 31, 2012

(54) WIND TURBINE WITH HYDRAULIC BLADE PITCH SYSTEM

(75) Inventors: Jesper Lykkegaard Andersen, Hornslet (DK); Jens Bay Madsen, Arhus (DK)

(73) Assignee: VESTAS WIND SYSTEMS A/S, Aarhus N. (DK)

(21) Appl. No.: 13/303,848

(22) Filed: Nov. 23, 2011

Related U.S. Application Data
(60) Provisional application No. 61/417,338, filed on Nov. 26, 2010.

(30) Foreign Application Priority Data
Nov. 26, 2010 (DK) PA 2010 70508

(51) Int. Cl. F03D 7/00

(52) U.S. Cl. 416/147

(57) ABSTRACT

A wind turbine is disclosed having a rotor with at least two blades and a blade pitch system for controlling the pitch angle of the blades. The blade pitch system comprises for each of the blades, a hydraulic blade pitch drive and at least two valves mutually connected in parallel for controlling a flow of liquid to the hydraulic blade pitch drive for that blade. The valves each comprises an arrangement for providing a variable flow of liquid.

### CROSS-REFERENCE TO RELATED APPLICATIONS

This application claims priority under 35 U.S.C. §119(a) to DK. Application No. PA 2010 70508 filed Nov. 26, 2010. This application also claims the benefit of U.S. Provisional Application Ser. No. 61/417,338 filed Nov. 26, 2010. Each of these applications is incorporated by reference herein in its entirety.

### TECHNICAL FIELD

The present invention relates to a wind turbine have a rotor with adjustable blades and a hydraulic blade pitch system for controlling the pitch angle of the blade.

### BACKGROUND

Wind turbines having blade pitch systems for adjusting the pitch angle of the blades have been known for many years, typically employing electric pitch drives or hydraulic pitch drives. Early examples of hydraulic pitch drives are disclosed, for example, in U.S. Pat. No. 4,348,155 and U.S. Pat. No. 4,352,634, both of United Technologies. The hydraulic valves used to control the flow of liquid to the linear hydraulic actuators are disclosed as switch valves, i.e. valves operated in an on-off mode and the pitching torque is not adjustable.

In EP 1 835 174 B1 of Robert Bosch GmbH is disclosed a wind turbine having a hydraulic pitch drive where the flow of liquid is controlled by means of a number of switch valves arranged in parallel and are operable in different combinations in order to provide what is known as digital hydraulics for precisely adjusting the flow of liquid to the hydraulic pitch drive. Thereby, the pitching torque, and thereby the pitch speed, can be adjusted to a required value.

The use of proportional hydraulic valves for controlling the flow of liquid to the hydraulic pitch drive is disclosed, for example, in EP1 533 520 of Hawe Hydraulik and in EP 2 072 815 of Gamesa. Proportional hydraulic valves allow for a precise adjustment of the flow of liquid to the hydraulic pitch drive and thereby, as well an adjustment of the pitch speed.

The location of wind turbines at geographical areas where the accessibility for maintenance and repair is difficult, such as off-shore locations and in dessert, mountain, and polar regions, there is a desire for systems in the wind turbine which are robust to malfunction of parts of the system, so that the operation of the wind turbine is not necessarily brought to a stop in case of component failure, but may be continued at full or partial load until, for example, scheduled maintenance of the wind turbine. Thereby, the percentage of operational time can be increased without requiring more maintenance and repair.

Thus, it is one aspect of the present invention to provide a hydraulic blade pitch system which has an improved robustness.

### SUMMARY

An embodiment of the present invention relates to a wind turbine having a rotor with at least two blades and a blade pitch system for controlling the pitch angle of the blades. The blade pitch system comprises, for each of the blades, a hydraulic blade pitch drive and at least two valves mutually connected in parallel for controlling a flow of liquid to the hydraulic blade pitch drive for that blade, wherein the valves each comprise an arrangement for providing a variable flow of liquid and wherein the at least two valves are proportional hydraulic spool valves.

Controlling the operation of the hydraulic blade pitch drive of a specific blade by means of two or more proportional hydraulic spool valves coupled in parallel is advantageous in that the size, and thereby the cost, of the individual valves can be reduced while at the same time ensuring the amount of fluid flowing through the valves can be adjusted even faster. In this regard, not only can the flow through the individual valves be adjusted, but according to embodiments of the present invention, the overall capacity can also be adjusted by controlling the number of valves that are engaged. Moreover, by using two or more valves coupled in parallel, the system is provided with redundancy in that if one valve fails, pitch operation can still continue by means of the remaining valves until the problem can be fixed or until operation of the wind turbine is stopped in a controlled fashion.

With the term hydraulic blade pitch drive is understood a part comprising at least one hydraulic motor, such as a linear actuator or an angular actuator, which is arranged to drive a rotation of the blade about a longitudinal axis thereof by providing a driving torque between the blade and the rotor hub to which the blade is connected by means of a pitch bearing.

A proportional hydraulic spool valve (in the following referred to as a proportional hydraulic valve) is a valve that may be controlled continuously between a closed position and a fully open position, normally by means of a proportional solenoid or a controlled pilot pressure in a pilot liquid or gas.

However, it should be emphasised that the term “proportional hydraulic spool valve” does include any kind of valve that controls the direction of hydraulic fluid flow by controlling the position of a spool so that channels in the hydraulic system are blocked or opened. The size of the flow through the valve is among other dependent on the spools actual position, which in turn is dependent on a control signal input. Hence, the “proportional” part of the term refers to the relationship between the control signal input (size, length etc.) and the spool position.

However, it should be emphasised that the relationship between the size of the flow through the valve and the size or length of the control signal in no way have to be directly proportional. For example, depending on the pressure drop over the valve and on the actual design of the valve and particularly the spool, the relationship between the size or length of the control signal and the size of the flow through the valve could be non-linear, i.e., the flow could increase exponentially or according to some kind of curve.

The spools position is typically controlled by a solenoid in accordance with the size of the voltage or current of the control signal supplying the solenoid, but other types of control signals are feasible.

The position of the spool could also be controlled by means of a motor whereby the time the motor was running would be substantially proportional with the position of the spool, but not necessary with the size of the flow as discussed above. A valve where the spool position is controlled by a motor is often referred to as servo valves.

A particularly preferred proportional hydraulic valve for the present invention is 4/3-way valves, i.e., valves having four ports, a pump port (P), a tank port (T) and two actuator ports (A, B), and three positions, a closed position, a position connecting the pump port (P) to actuator port A and tank port (T) to actuator port B, and a third position connecting the pump port (P) to actuator port B and tank port (T) to actuator port A. In the two latter positions, the opening of the valve may be controlled continuously between the closed position and a fully open position.

The proportional hydraulic valves are mutually connected in parallel which means that the outlet ports (actuator ports) of the valves are connected to the inlet port or ports of the hydraulic blade pitch drive so that the inlet port or ports may be fed with a flow of pressurised liquid from each of the parallel connected proportional hydraulic valves. For example, a linear hydraulic actuator, i.e., a hydraulic cylinder, a port to an inner chamber, the bottom chamber or the piston rod chamber, is an inlet port when the piston is moved in one direction and an outlet port when the piston is moved in the opposite direction. However, the flow from a port when acting as an outlet port may be drained from the hydraulic actuator without passing the proportional hydraulic valves, as exemplified below. In one embodiment, the flow to the hydraulic blade pitch drive may be provided from all of the at least two proportional hydraulic valves simultaneously. In other embodiments, the control system is adapted to only allow the proportional hydraulic valves to operate and feed a flow of liquid to a given port alternately. In a particular embodiment, the two or more proportional hydraulic valves are furthermore mutually connected in parallel so that at least one return flow of liquid from the hydraulic blade pitch drive may be received by all of the at least two proportional hydraulic valves simultaneously.

By providing at least two proportional hydraulic valves connected in parallel to each other, several advantages are obtained. The plurality of proportional valves connected in parallel will provide a redundancy to the system, so that the malfunction of one of the valves will not hinder the operation of the wind turbine. Furthermore, the provision of two or more proportional valves instead of one enables the use of smaller, off-the-shelve components for even larger wind turbines, which components are less expensive and generally have a high reliability.

In one particular embodiment, at least one of the valves is arranged to be inoperative at relatively lower pitch speeds and to be operated together with one or more of the remaining of the valves for providing relatively higher pitch speeds.

In another embodiment, one of the valves is arranged to be operated as a back-up in case of a malfunction of one or more of the remaining of the valves.

In one embodiment, the hydraulic blade pitch system of the wind turbine comprises three valves connected in parallel for controlling the flow of liquid to the hydraulic blade pitch drive for each blade. Thereby, the valves may be designed so that full redundancy is provided, i.e., so that the normal operation is maintained with the use of two of the three proportional valves.

In another embodiment, the two or more proportional valves in parallel are applied in a wind turbine where the hydraulic blade pitch drive for each of the blades comprises at least two linear hydraulic actuators, in particular three linear hydraulic actuators, connected to the blade and to a rotor hub of the rotor. The parallel connected proportional hydraulic valves are arranged to control the flow of liquid to each of the linear hydraulic actuators of that blade. In a simple embodiment of such a pitch drive system, the actuators of the hydraulic blade pitch drive for each of the blades are of identical configuration, i.e., have the same piston area and piston rod area and are arranged to operate in the same direction with respect to the blade, and may therefore be mutually connected in parallel so that the piston rod chambers of the actuators are mutually connected and the bottom chambers of the actuators are mutually connected.

It is furthermore an advantageous embodiment of the present invention that the pitch drive system of the wind turbine comprises valve means arranged for selectively separating the parallel connection of the valves, so that a malfunctioning valve may be separated from the remaining of the system in order to avoid a possible negative influence on the operability of the system from the malfunctioning valve.

In yet an advantageous arrangement in accordance with an embodiment of the present invention, the hydraulic blade pitch drive for each of the blades comprises at least one linear hydraulic actuator connected to the blade and to a rotor hub of the rotor and wherein the at least two parallel connected valves are arranged to provide a flow of liquid to a piston rod chamber(s) of the hydraulic linear actuator(s) via at least one first one-way valve and the piston rod chamber(s) is/are connected to a pressure line for providing pressurised fluid to the valves via a second one-way valve so as to allow regeneration of the pressure.

### BRIEF DESCRIPTION OF THE DRAWINGS

Embodiments of the present invention are discussed in the following with reference to the enclosed drawings, of which

FIG. 1 illustrates a large modern wind turbine as seen from the front;

FIG. 2 illustrates a wind turbine hub comprising three blades as seen from the front;

FIG. 3 illustrates a simplified cross section of a wind turbine nacelle as seen from the side;

FIG. 4 is a diagram of a first embodiment of the invention;

FIG. 5 is a diagram of a second embodiment of the invention; and

FIG. 6 is a diagram of a third embodiment of the invention.

### DETAILED DESCRIPTION

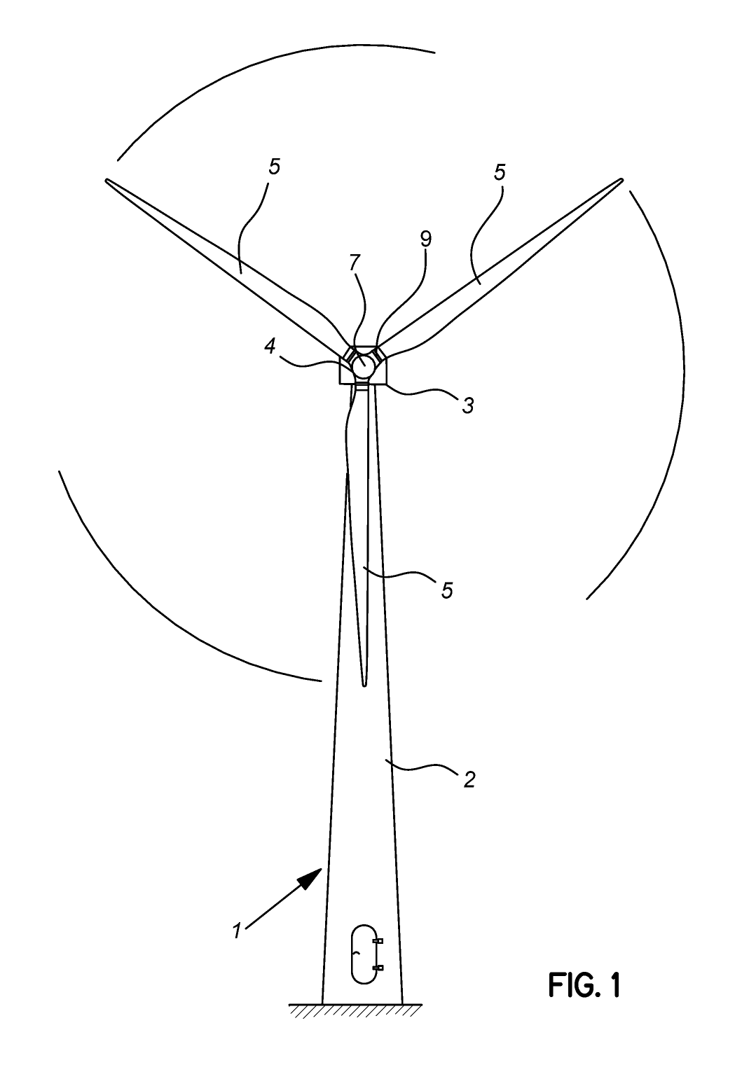

FIG. 1 illustrates a wind turbine 1, comprising a tower 2 and a wind turbine nacelle 3 positioned on top of the tower 2. The wind turbine rotor 4, comprising three wind turbine blades 5, is connected to the nacelle 3 through the low speed shaft which extends out of the nacelle 3 front.

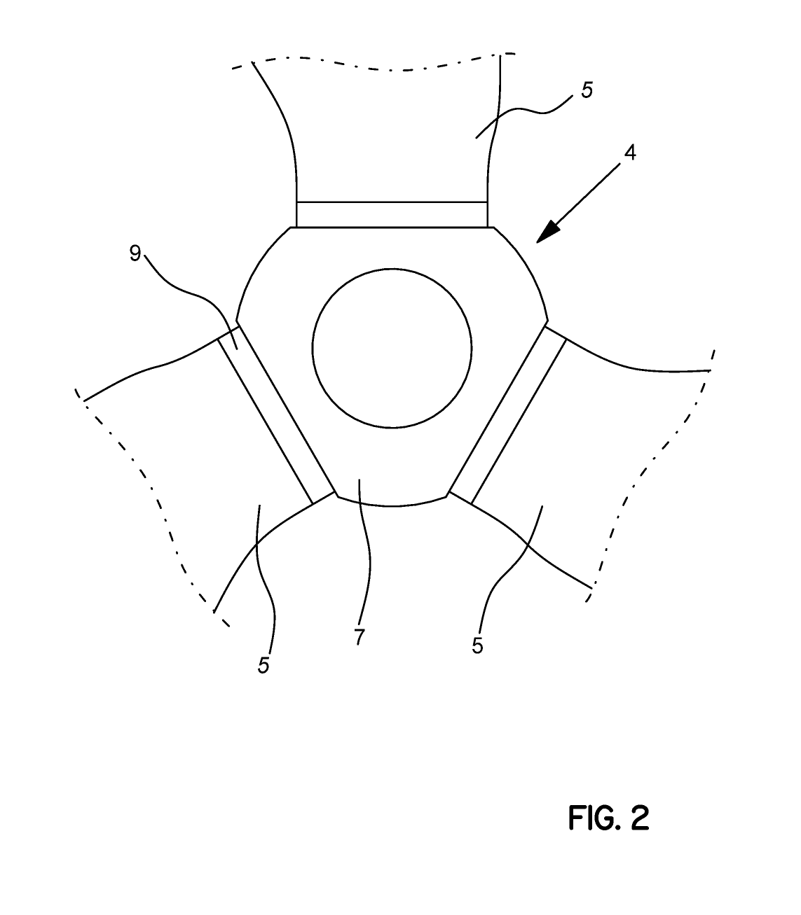

FIG. 2 illustrates a wind turbine rotor 4 comprising a hub 7 and three blades 5 as seen from the front.

As illustrated, the pitch bearings 9 are arranged between the blades 5 and the hub 7 to enable that the blades 5 can be rotated around their longitudinal axis and to transfer forces mainly from three different sources. The blades 5 (and the bearings 9 themselves of course) are under constant influence of the force of gravitation. The direction of the gravitational force varies depending on the blade's 5 position, inducing different loads on the pitch bearings 9. When the blade is in motion the bearing 9 is also under influence of a centrifugal force, which mainly produces an axial pull in the bearing 9. Finally, the bearings 9 are under influence of the wind load on the blades 5. This force is by far the greatest load on the bearings 9 and it produces a massive moment, which the bearings 9 have to stand.

The load on and from all the pitch bearings 9 has to be transferred to the hub 7 and further into the rest of the wind turbine 1, and the pitch bearing 9 at the same time has to enable that the blade 5 can be pitched.

In this embodiment, the rotor 4 comprises three blades 5 but in another embodiment the rotor 4 could comprise one, two, four or more blades 5.

In this embodiment, the wind turbine 1 is a pitch regulated wind turbine 1, but in another embodiment the wind turbine could just as well be an active stall regulated wind turbine 1 since both pitch regulated wind turbines 1 and active stall regulated wind turbines 1 comprises a hydraulic blade pitch system 6 for pitching the blades 5.

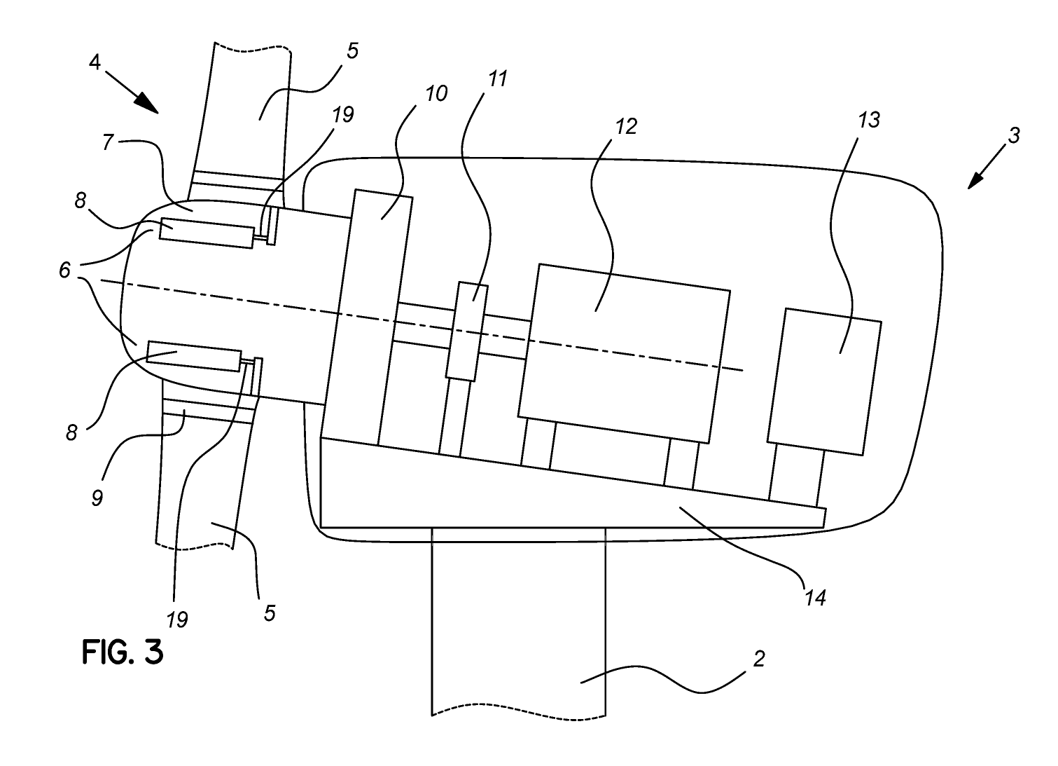

FIG. 3 illustrates a simplified cross section of a nacelle 3 of a prior art wind turbine 1, as seen from the side. Nacelles 3 exist in a multitude of variations and configurations, but in most cases the drive train in the nacelle 3 almost always comprises one or more of the following components: a gearbox 10, a coupling (not shown), some sort of braking system 11 and a generator 12. A nacelle 3 of a modern wind turbine 1 can also include a converter 13 (also called an inverter) and additional peripheral equipment, such as further power handling equipment, control cabinets, hydraulic systems, cooling systems and more.

The weight of the entire nacelle 3 including the nacelle components 10, 11, 12, 13 is carried by a nacelle structure 14. The components 10, 11, 12, 13 are usually placed on and/or connected to this common load carrying nacelle structure 14. In this simplified embodiment, the load carrying nacelle structure 14 only extends along the bottom of the nacelle 3, for example, in the form of a bed frame to which some or all the components 10, 11, 12, 13 are connected. In another embodiment, the load carrying structure 14 could comprise a gear bell which through a main bearing (not shown) could transfer the load of the rotor 4 to the tower 2. Alternatively, the load carrying structure 14 could comprise several interconnected parts such as latticework.

In this embodiment, the hydraulic blade pitch system 6 comprises a rotating device or means for rotating the blades 5 in the form of hydraulic linear actuators 15a, 15b, 15c connected to the hub 7 and the respective blades 5.

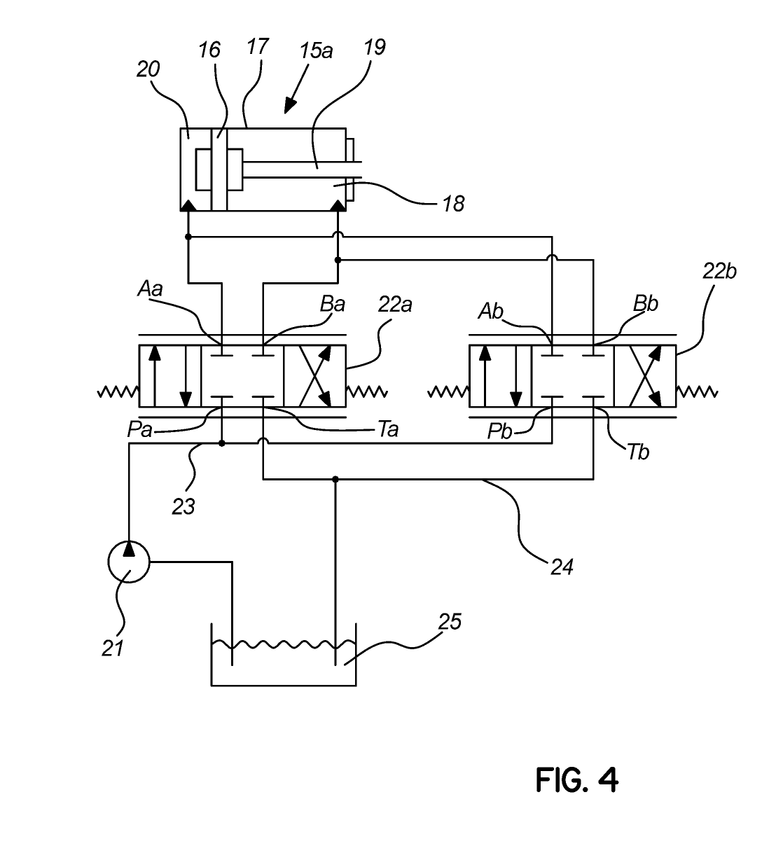

FIG. 4 is a diagram of main components of a hydraulic blade pitch system for a single blade 5 of a wind turbine 1 according to a first embodiment of the present invention. The system comprises a linear hydraulic actuator 15a with a piston 16 arranged displaceable within a cylinder 17 which is divided by the piston 16 into a piston rod chamber 18 or front chamber (the internal chamber comprising the piston rod 19) of the cylinder 17 and a bottom chamber 20 or rear chamber (the internal chamber which does not comprise the piston rod 10). The piston rod 19 is connected (not shown) to the hub 7 of the wind turbine rotor 4 and the cylinder 17 is connected (not shown) to the blade 5 so as to effect an angular displacement of the blade 5 when liquid under pressure is applied to the piston rod chamber 18 or to the bottom chamber 20. The flow of pressurised liquid from the hydraulic pump 21 to the linear hydraulic actuator 15a is controlled by means of two proportional hydraulic valves 22a, 22b. The hydraulic pump 21 may be arranged for each blade as shown in FIG. 4 or may be a central arrangement for providing pressurised liquid to the hydraulic blade pitch systems for each of the blades 5.

The proportional hydraulic valves 22a, 22b, have pressure ports Pa, Pb connected via the pressure line 23 to the hydraulic pump 21 and tank ports Ta, Tb, connected via the tank line 24 to the low pressure tank 25. One actuator port Aa, Ab of each valve 22a, 22b, connects to the bottom chamber 20 of the hydraulic linear actuator 15a, whereas the other actuator ports Ba, Bb are connected to the piston rod chamber 18 of the hydraulic linear actuator 15a.

The proportional hydraulic valves 22a, 22b are biased by springs towards a neutral centre position in which the ports are closed and no liquid flows through the valves. The valves 22a, 22b may be shifted in one direction by means of solenoids or a controlled pressurised pilot liquid so that the pressure ports Pa, Pb are gradually opened towards the first actuator ports Aa, Ab and the tank ports Ta, Tb are gradually opened towards the second actuator ports Ba, Bb, or the valves 22a, 22b may be shifted in the opposite direction causing the pressure ports Pa, Pb to be gradually opened towards the second actuator ports Ba, Bb and the tank ports Ta, Tb to be gradually opened towards first actuator ports Aa, Ab. Thus, the operation of the proportional hydraulic valves 22a, 22b, may be used to selectively move the piston 16 in one or the other direction so as to pitch the blade with a controlled and variable pitch speed in one direction or the other. The two valves 22a, 22b, may be operated synchronous so that the flow through the valves are substantially equal or they may alternatively be operated so that one of the valves 22a, 22b, is operated for lower flow rates, and thus lower pitch speeds, whereas the other of the valves 22a, 22b only is operated when a higher pitch speed is required. In a further alternative, only one of the valves 22a, 22b is operated under ordinary operation of the wind turbine and the other valve is only operated in case of malfunction of the first valve 22a, 22b. The provision of two proportional hydraulic valves 22a, 22b provide the hydraulic blade pitch system with a redundancy so that the system is operable even though on of the valves should malfunction.

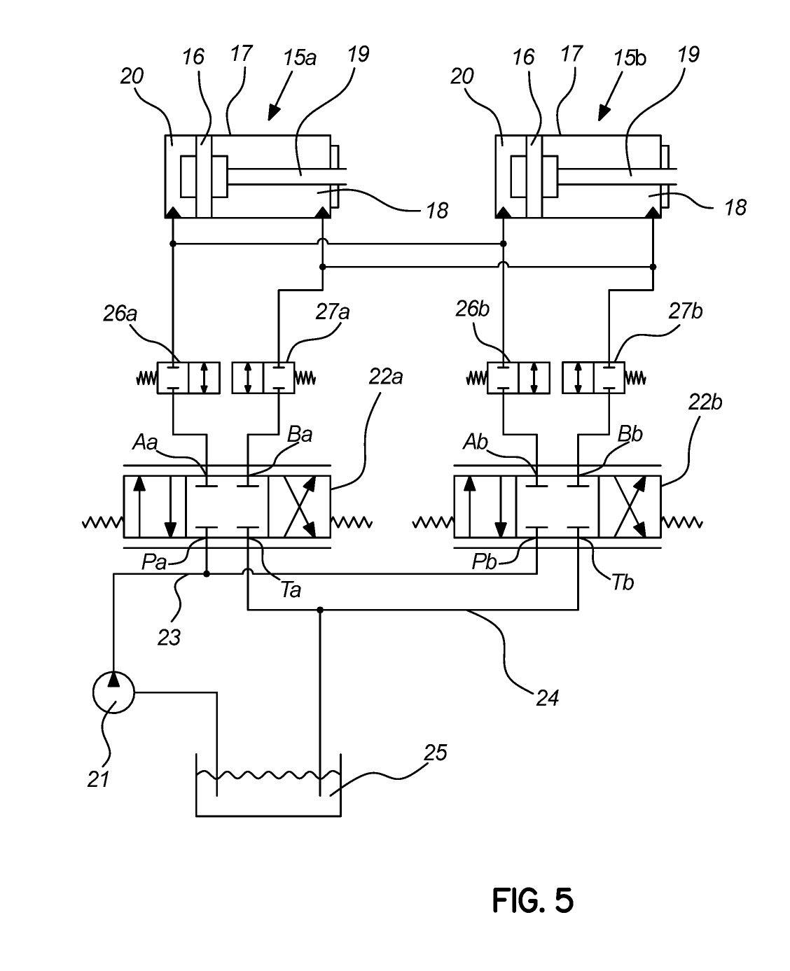

In FIG. 5 is a diagram of main components of a hydraulic blade pitch system for a single blade 5 of a wind turbine 1 according to a second embodiment of the present invention. The system comprises two linear hydraulic actuators 15a, 15b connected in parallel and both arranged to adjust the pitch angle of the same wind turbine blade 5.

The parallel connection of the two actuators includes that the piston rod chambers 18 and the bottom chambers 20 of the actuators 15a, 15b are mutually connected to each other with liquid connection lines as clearly shown on the diagram in FIG. 5. The general arrangement of the hydraulic blade pitch system shown in FIG. 5 is similar to the one shown in FIG. 4.

However, the arrangement of FIG. 5 has a particular feature for selectively separating a malfunctioning proportional valve 22a, 22b from the remaining of the system in order to avoid a possible negative influence on the operability of the system from the malfunctioning proportional valve 22a, 22b. According to this particular feature, which could also be applied to the system of FIG. 4, the lines connecting the first actuator ports Aa, Ab of the hydraulic proportional valves 22a, 22b with the bottom chambers 20 of the hydraulic linear actuators 15a, 15b are equipped with 2/2-way poppet-type valves 26a, 26b and the lines connecting the second actuator ports Ba, Bb to the piston rod chambers 18 of the hydraulic linear actuators 15a, 15b are also equipped with 2/2-way poppet-type valves 27a, 27b. These poppet valves 26a, 26b, 27a, 27b are spring biased towards a closed position in which no liquid flows through the valves 26a, 26b, 27a, 27b and the valves may be operated to the open position during normal operation of the hydraulic blade pitch system by means of solenoids or a controlled pressurised pilot liquid.

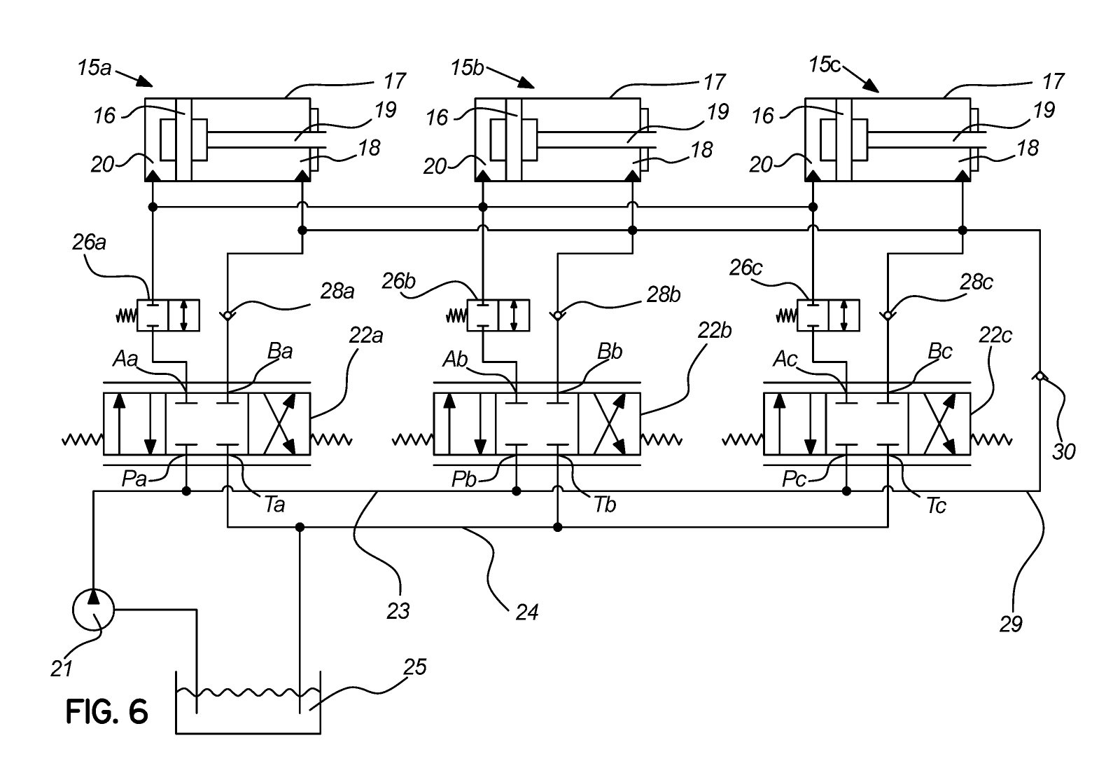

In FIG. 6 is a diagram of main components of a hydraulic blade pitch system for a single blade 5 of a wind turbine 1 according to a third embodiment of the present invention. The system comprises three linear hydraulic actuators 15a, 15b, 15c connected in parallel and both arranged to adjust the pitch angle of the same wind turbine blade 5, as well as three proportional hydraulic valves 22a, 22b, 22c mutually connected in parallel for controlling a flow of liquid to the linear hydraulic actuators 15a, 15b, 15c.

The parallel connection of the three actuators includes that the piston rod chambers 18 and the bottom chambers 20 of the actuators 15a, 15b, 15c are mutually connected to each other with liquid connection lines as clearly shown on the diagram in FIG. 6. The general arrangement of the hydraulic blade pitch system shown in FIG. 6 is similar to the ones shown in FIGS. 4 and 5. When three proportional hydraulic valves 22a, 22b, 22c are provided mutually connected in parallel it is possible to design the hydraulic blade pitch system so that only two valves will suffice for normal operation of the wind turbine and one valve is redundant. Accordingly, it is achieved that the system may be made from off-the-shelf proportional valves and that full redundancy in case of malfunction of one of the proportional valves is obtained.

The arrangement of FIG. 6 has a further particular feature for selectively separating a malfunctioning proportional valve 22a, 22b, 22c from the remaining of the system in order to avoid a possible negative influence on the operability of the system from the malfunctioning proportional valve 22a, 22b, 22c. This feature is presented as an alternative to the arrangement for separating a malfunctioning valve shown in FIG. 5. According to this particular feature, which could also be applied to the system of FIGS. 4 and 5, the lines connecting the first actuator ports Aa, Ab, Ac of the hydraulic proportional valves 22a, 22b, 22c with the bottom chambers 20 of the hydraulic linear actuators 15a, 15b, 15c are equipped with 2/2-way poppet-type valves 26a, 26b and the lines connecting the second actuator ports Ba, Bb, Bc to the piston rod chambers 18 of the hydraulic linear actuators 15a, 15b, 15c are instead equipped with check valves 28a, 28b, 28c that ensure that liquid may flow from the pressure line 23 through the proportional valves 22a, 22b, 22c and to the piston rod chambers 18 of the hydraulic linear actuators 15a, 15b, 15c, but hinder a flow of liquid in the opposite direction from the piston rod chamber 18 through the proportional valves 22a, 22b, 22c and to the tank line 24. Instead, when the proportional valves 22a, 22b, 22c are operated to allow a flow of liquid from the pressure line 23 to the bottom chambers 20 of the hydraulic linear actuators 15a, 15b, 15c, the liquid, which is pressed out from the piston rod chambers 18, passes through a separate return line 29 equipped with a check valve 30 and to the pressure line 23 so as to regenerate the pressure. This is possible because the area of the piston 16 area facing the bottom chamber 20 is larger than the piston 16 area on the side facing the piston rod chambers 18 due to the presence of the piston rod 19. Thus, the pressure of the liquid in the piston rod chambers 18 will be larger than the pressure of the liquid in the bottom chambers 20 which allow for the regeneration. In an alternative embodiment, one of the check valves 28a, 28b, 28c is controllable to an open position, so that the liquid content of the piston rod chambers 18 may drain to the tank line 24 instead of the pressure line 23 in case a higher pressure difference over the pistons 16, and thus a higher pitching torque, is requested.

### LIST OF REFERENCE NUMBERS AND SYMBOLS

1. Wind turbine
2. Tower
3. Nacelle
4. Rotor
5. Blade
6. Hydraulic blade pitch system
7. Hub
8. Hydraulic blade pitch drive
9. Pitch bearing
10. Gearbox
11. Brake
12. Generator
13. Converter
14. Nacelle structure
15a. First linear hydraulic actuator
15b. Second linear hydraulic actuator
15c. Third linear hydraulic actuator
16. Piston
17. Cylinder
18. Piston rod chamber
19. Piston rod
20. Bottom chamber
21. Hydraulic pump
22a. First 4/3-way proportional hydraulic valve
22b. Second 4/3-way proportional hydraulic valve
22c. Third 4/3-way proportional hydraulic valve
23. Pressure line
24. Tank line
25. Tank
26a. Poppet-type 2/2-way valve connecting the first actuator port of the first proportional hydraulic valve to the bottom chambers of the hydraulic linear actuators
26b. Poppet-type 2/2-way valve connecting the first actuator port of the second proportional hydraulic valve to the bottom chambers of the hydraulic linear actuators
26c. Poppet-type 2/2-way valve connecting the first actuator port of the third proportional hydraulic valve to the bottom chambers of the hydraulic linear actuators
27a. Poppet-type 2/2-way valve connecting the second actuator port of the first proportional hydraulic valve to the piston rod chambers of the hydraulic linear actuators
27b. Poppet-type 2/2-way valve connecting the second actuator port of the second proportional hydraulic valve to the piston rod chambers of the hydraulic linear actuators
28a. Check valve connecting the second actuator port of the first proportional hydraulic valve to the piston rod chambers of the hydraulic linear actuators
28b. Check valve connecting the second actuator port of the second proportional hydraulic valve to the piston rod chambers of the hydraulic linear actuators
28c. Check valve connecting the second actuator port of the second proportional hydraulic valve to the piston rod chambers of the hydraulic linear actuators
29. Return line
30. Check valve arranged in the return line
Ta Tank port of the first proportional hydraulic valve
Tb Tank port of the second proportional hydraulic valve
Tc Tank port of the third proportional hydraulic valve
Pa Pressure port of the first proportional hydraulic valve
Pb Pressure port of the second proportional hydraulic valve
Pc Pressure port of the third proportional hydraulic valve
Aa First actuator port of the first proportional hydraulic valve
Ab First actuator port of the second proportional hydraulic valve
Ac First actuator port of the third proportional hydraulic valve
Ba Second actuator port of the first proportional hydraulic valve
Bb Second actuator port of the second proportional hydraulic valve
Bc Second actuator port of the third proportional hydraulic valve

1. A wind turbine, comprising:
a rotor including at least two blades; and
a blade pitch system for controlling the pitch angle of the blades, the blade pitch system comprising, for each of the blades:
a hydraulic blade pitch drive; and
at least two valves mutually connected in parallel for controlling a flow of liquid to the hydraulic blade pitch drive for that blade,
wherein the at least two valves each comprise an arrangement for providing a variable flow of liquid, and
wherein the at least two valves are proportional hydraulic spool valves.

2. The wind turbine according to claim 1, wherein the proportional hydraulic spool valves include 4/3-way valves.

3. The wind turbine according to claim 1, wherein the at least two valves includes three valves connected in parallel for controlling the flow of liquid to the hydraulic blade pitch drive for each blade.

4. The wind turbine according to claim 1, wherein at least one of the at least two valves is arranged to be inoperative at relatively lower pitch speeds and to be operated together with one or more of the other at least two valves for providing relatively higher pitch speeds.

5. The wind turbine according to claim 1, wherein one of the at least two valves is arranged to be operated as a back-up in case of a malfunction of one or more of the other at least two valves.

6. The wind turbine according to claim 1, wherein the hydraulic blade pitch drive for each of the blades further comprises:
at least two linear hydraulic actuators connected to the blade and to a rotor hub of the rotor,
wherein the at least two parallel connected valves are arranged to control the flow of liquid to each of the linear hydraulic actuators of that blade.

7. The wind turbine according to claim 6, wherein the hydraulic blade pitch drive for each of the blades comprises three linear hydraulic actuators connected to the blade and to the rotor hub of the rotor.

8. The wind turbine according to claim 6, wherein the linear hydraulic actuators of the hydraulic blade pitch drive for each of the blades are of identical configuration and are mutually connected in parallel so that the piston rod chambers of the actuators are mutually connected and the bottom chambers of the actuators are mutually connected.

9. The wind turbine according to claim 1, further comprising valve means arranged for selectively separating the parallel connection of the valves.

10. The wind turbine according to claim 1, wherein the hydraulic blade pitch drive for each of the blades comprises:
at least one linear hydraulic actuator connected to the blade and to a rotor hub of the rotor,
wherein the at least two parallel connected valves are arranged to provide a flow of liquid to a piston rod chamber of the hydraulic linear actuator via a first one-way valve and the piston rod chamber is connected to a pressure line for providing pressurised fluid to the valves via a second one-way valve so as to allow regeneration of the pressure.
